(19) United States
(12) Patent Application Publication
(10) Pub. No.: US 2012/0325841 A1
(43) Pub. Date: Dec. 27, 2012

(54) Pizza Box Stacker, Carrier and Dispenser

(76) Inventor: Rusty A. Restaino, Yonkers, NY (US)

(21) Appl. No.: 13/166,154

(22) Filed: Jun. 22, 2011

(51) Int. Cl. B65G 59/06; B65D 83/00; B31B 3/00

(52) U.S. Cl. 221/282; 493/162

(57) ABSTRACT

A stacker, dispenser, and carrier for pizza boxes has a rectangular parallelepiped formed with a front opening for withdrawing boxes and a rear opening for temporarily sliding the lowermost box off stops on which the stack is mounted. The lowermost box can be pushed rearward through the opening, have its front lowered, and than be withdrawn through the frontal opening of the box. A vertical window shows the height of the stack so that there is no room to add more boxes.

### BACKGROUND OF THE INVENTION

It is a common sight at pizzerias to see pizza boxes stacked on a counter in a work area near a pizza oven. Before removing a pizza from the oven, the pizza man withdraws a box from the stack, opens it up, and then places a hot pizza inside the box.

As many as 40 or more boxes may be placed on a stack. Pulling one out from or near the bottom of the stack can be difficult in that the weight of the boxes on top of the one being withdrawn causes substantial friction between the upper surface of the box to be withdrawn and lower surface of the box above it. Moreover, as boxes are withdrawn the stack can be jostled resulting in the stack becoming misaligned and possibly falling over.

Various attempts to facilitate the removal of pizza boxes from a stack have resulted in apparatuses which are complicated and expensive to construct and/or which do not solve the problem of reducing friction between the boxes. For example, U.S. Patent Application Publication No. 2008/0224577 by Whitty for an Apparatus for Storing and Dispensing a Plurality of Boxes discloses a rectangular cage which is open at the top to receive pizza boxes to be stacked on the floor of the dispenser. A stack of boxes may also be inserted by opening a front door of the cage which has a bottom that is raised from the floor of the cage to provide a slot through which pizza boxes can be removed by pulling them forward. An optional guide wall urges the boxes forward through the slot.

U.S. Pat. No. 5,328,258 to Scalise for a Pizza Box Storage and Dispensing Assembly describes a rectangular stacker with two telescoping sections for varying the height of the device. Springs are used to grasp the pizza boxes and keep their weight off of the bottom box so that it can be easily withdrawn. Vertical corner sections project inwardly to prevent all but the lowermost of the boxes from moving forwardly and extend short of the bottom of the assembly for providing a widened slot through which the lowermost box can be removed. The height of the stack can be determined by viewing the boxes through the opening between the corner sections. A downwardly inclined plate facilitates removal of the boxes through the slot.

A basic dispenser for flat rectangular boxes which are pulled from the bottom of a stack through a horizontal opening is the subject of U.S. Pat. No. 1,986,101 to Brodsky. Brodsky teaches that the dispenser can be made by folding a sheet of cardboard having score lines to define the panels of the dispenser.

U.S. Patent Application Publication No. 2004/0188365 by Forte discloses a stacker that can handle a single stack of pizza boxes or multiple stacks side-by-side. The device has rear and side walls with an open front for containing the boxes while permitting the height of the stack to be viewed. There is an enlarged horizontal opening at the bottom for enabling withdrawal of the lowermost box from the stack.

U.S. Pat. No. 3,301,388 to Rockwell discloses a Playing Card Dispenser having a stand or frame for supporting a rectangular cartridge filled with boxes of playing cards. The cartridge has a delivery opening at its bottom for removing the lowest box in the stack. The side walls are notched to allow the box to be grasped. Rockwell also teaches that his dispenser can be made by folding a sheet of cardboard having score lines to define the panels of the dispenser.

U.S. Pat. No. 4,769,573 to Celik for a Tape Cassette Dispenser features a transparent rectangular enclosure with a horizontal inwardly notched slot at the bottom of the front wall through which the lowest tape cassette in a stack can be extracted. A similar tape dispenser is disclosed in U.S. Pat. No. 5,515,999 to Jo for an Audio Cassette Displayer and Dispenser.

U.S. Pat. No. 4,597,614 to Alexander for a Storage Dispenser Rack for Rectangular Articles discloses a container with multiple openings at differing heights through which stacked video cassettes and other rectangular articles can be withdrawn.

None of the above patents discloses a dispenser as simple and cost effective as the one of the present invention. In addition to being used as a stacker and dispenser, the container of the present invention also serves as a carrier. When formed from a lightweight material such as corrugated cardboard, one of the panels of the container can be grasped in one hand at the top and carried from one place to another while front and rear supports keep the pizza boxes securely within the container.

### DESCRIPTION OF THE DRAWINGS

FIG. 1 is a perspective view of a filled pizza box stacker, dispenser and carrier in accordance with the preferred embodiment of the invention.

FIG. 2 is a rear elevation view of the apparatus of FIG. 1.

FIG. 3 is a top plan view of the apparatus of FIG. 1 in an empty state.

FIG. 4 is a side sectional elevation view of the apparatus of the invention taken through line 4,5-4,5 of FIG. 3.

FIG. 5 is a side sectional elevation view of the apparatus of the invention as shown in FIG. 4 in a later stage of use.

FIG. 6 is a perspective view of the apparatus of the invention in a later stage of use than that shown in FIG. 5.

FIG. 7 is a sectional side elevation view of the apparatus of the invention in a still later stage than that shown in FIG. 6.

FIG. 8 is a plan view of a sheet of material from which the preferred embodiment of the invention can be assembled.

FIG. 9 is a partial perspective view showing a portion of the preferred embodiment of the invention.

FIG. 10 is a partial perspective view showing a portion of a first alternate preferred embodiment of the invention.

FIG. 11 is a partial perspective view showing a portion of a second alternate preferred embodiment of the invention.

### DESCRIPTION OF THE PREFERRED EMBODIMENT

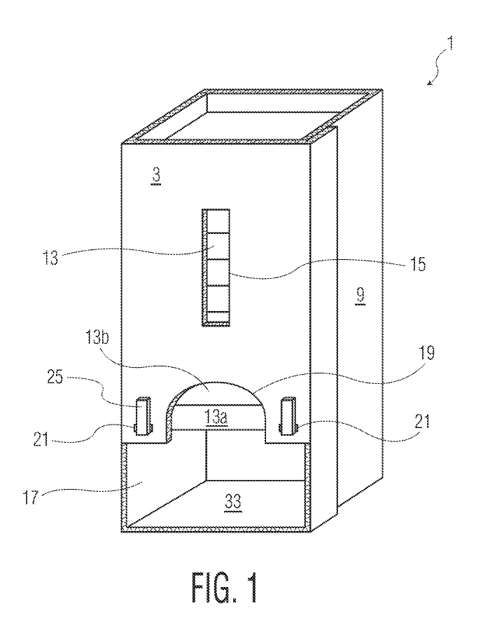

Referring now to FIGS. 1-3 of the drawings there is shown a container 1, for serving as a pizza box stacker dispenser and carrier, in the general form of a hollow upright rectangular parallelepiped having a front panel 3, a rear panel 5, a left side panel 7 and a right side panel 9. The container 1 has an open top 11 through which a stack of conventional pizza boxes 13 may be inserted to form a stack. Although described for use in storing, carrying, and dispensing pizza boxes, the present invention is applicable generally to storing, carrying, and dispensing other types of boxes or other uniformly sized rectangular objects preferably having a low profile.

On the front panel 3 of the container 1 there is a centered vertical slot 15 forming a window in the panel 3 through which a portion of the stack of boxes can be seen. The window 15 provides a view from which it can be determined when it is necessary to refill the container 1 with more pizza boxes after a sufficient number have been withdrawn from the bottom of the container 1 as hereinafter explained.

At the bottom of the container 1 there is a rectangular lower opening 17 having a width slightly larger than the width of the pizza boxes intended to be stored within the container 1 and dispensed from it. Continuous with the opening 17 at the bottom of the container 1 is an upper opening 19 having a width narrower than the width of the pizza boxes 13.

The opening 19 is wide enough to enable the lowermost pizza box 13a in the container 1 to be grasped, preferably with the thumb of one hand pressing against the front edge of the box and the fingers of the same hand touching the box from below. The opening 19 preferably has a rounded top to form an arch for structural integrity and an aesthetically pleasing appearance.

On each side of the opening 19 there is inserted through a horizontal slot 21 in the front panel 3 of the container 1, a right angle bracket 25 serving as a support for the bottom of the lowermost pizza box 13a in an area proximate the front panel of the container 1. Although shown as mounted on the front panel 3 of the container 1, the supports 25 can be mounted on the inside surfaces of the left side panel 7 and right side panel 9 adjacent the inside surface of the front panel 3.

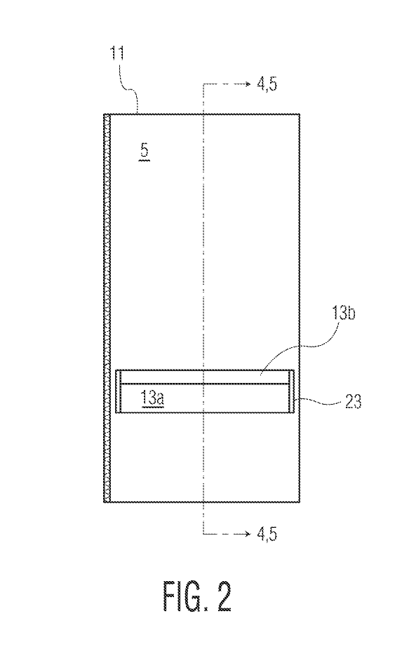

Referring now to FIG. 2 of the drawings there is shown the rear panel 5 of the container 1. Cut into the rear panel 5 of the container 1 is a rectangular opening 23 having a width slightly larger than the width of the boxes 13 and a height greater than the height of a single box 13 but less than twice the height of a box 13. Hence one box 13, and only one box 13, may be received within the rear opening 23 at a time.

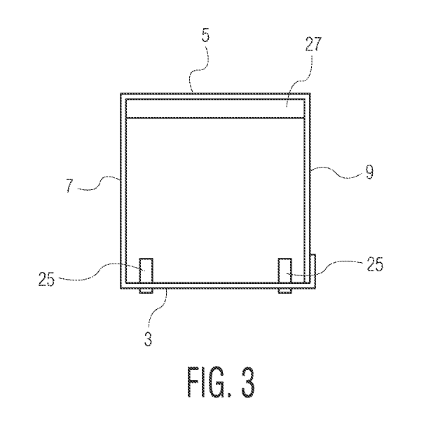

Referring to FIG. 3 of the drawings, looking down into the container 1, there can be seen the horizontal surfaces of front supports 25 formed by brackets which support the bottom of the lowermost pizza box in the stack of boxes 13 housed within the container 1, and a horizontal ledge of a rear support 27 beneath the rear opening 19. The uppermost surface of the rear support ledge, the uppermost surfaces of the horizontal portions of the brackets 25, and the bottom of the rectangular opening 23 are in the same horizontal plane, i.e., transverse to the panels 3, 5, 7 and 9.

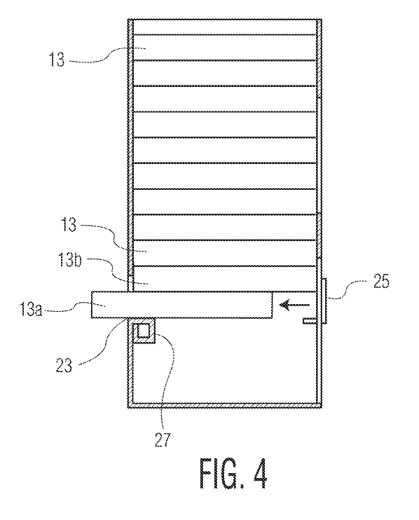

Referring now to FIG. 4 of the drawings there is shown a stack of pizza boxes 13 within a container 1 from which the lowermost box 13a is to be removed. As can be seen in FIG. 4, the lowermost box 13a has been pushed, by inserting pressure on its front panel, exposed in the upper opening 19 of the container 1, toward the rear of the container 1 thereby causing the lowermost box 13a to partially pass through the rectangular opening 23 to a position at which the front of the lowermost box 13a has cleared and is rearward of the supports 25 on which it was resting.

During movement through the rear slot, the lowermost box 13a remains supported by the rear support 27. At this time the area of the top surface of the lowermost box 13a within the container 1 continues to engage the bottom surface of the box 13b immediately above it, with the weight of the stack of boxes causing friction between the lowermost box 13a being dispensed and the box 13b above it.

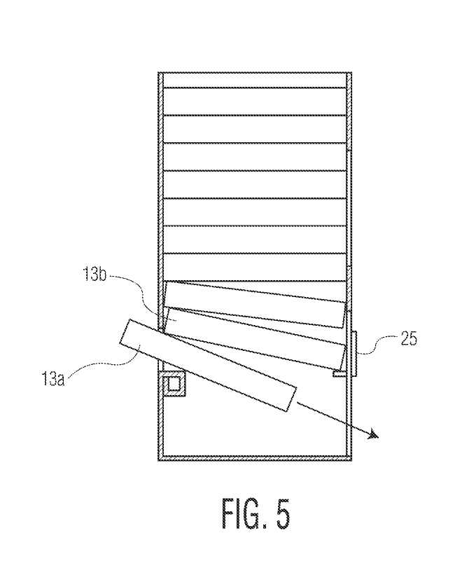

Referring now to FIG. 5, as soon as the lowermost box 13a clears the bracket 25, it may be tilted downward in a direction so that the box is aimed at the bottom opening 17 in the container 1. As the lowermost box 13a is tilted downward, it disengages the box 13b above it except for a line of engagement along the bottom rear edge of the engaging box. This greatly reduces the amount of friction between the boxes 13a and 13b and the force which must be exerted on the lowermost box 13a to withdraw it from the container 1 below the force that would have to be exerted if the lowermost box 13a were withdrawn while its entire surface area within the container 1 was in engagement with the bottom surface of the box 13b immediately above it.

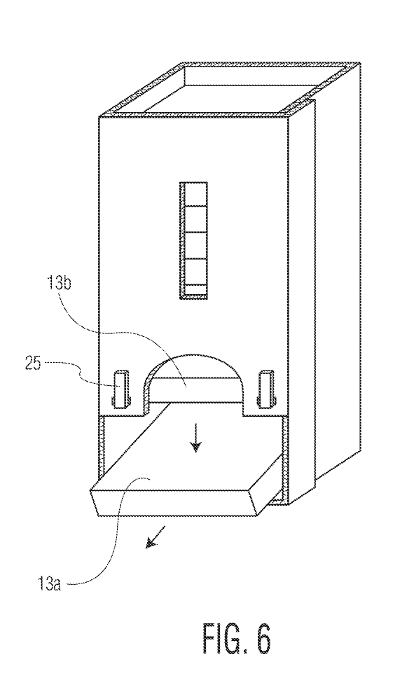

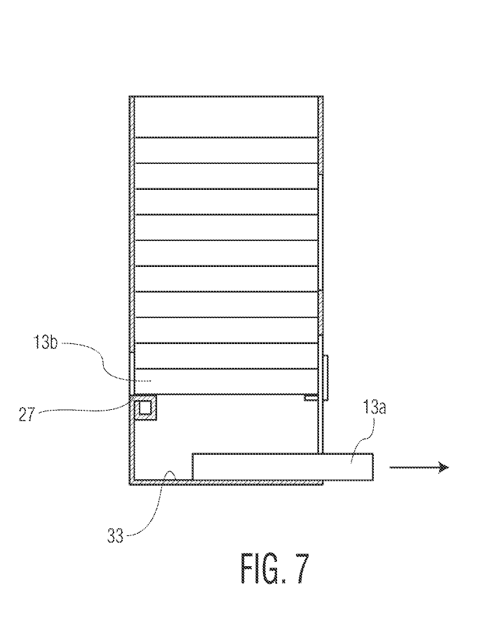

As can further be seen in FIG. 5, as the lowermost box 13a is tilted downward, having cleared the bracket 25, the box 13b immediately above it also tilts downward until its front lands on the horizontal portion of the bracket 25. The bracket 25 prevents the box 13b from falling any further. Referring to FIGS. 6 and 7, as the downward tilted lowermost box 13a is pulled from the dispenser its rear edge clears the rear support 27 and drops to the floor 33 of the container 1. At this time, the next to lowermost box 13b drops down onto the rear support 27 and assumes a horizontal disposition as do all of the boxes above it. The lowermost box 13a is now free of all friction from the box above it and can be easily withdrawn from the container 1.

The floor 33 of the container 1 is optional and not necessary to its dispensing function. However, the floor 33 provides a smooth surface for withdrawing the box to be dispensed with little friction and also enhances the rigidity of the container 1. Another benefit of the floor 33 is that it protects the boxes 13 from the surface of the countertop on which the container 1 is placed including any debris which may be present on the countertop.

In order to provide ample room for the lowermost box 13a to be momentarily pushed rearwardly through the opening 23, the container 1 should be spaced from the wall behind it. This can be done by placing a spacer (not shown) on the top of the counter on which the container 1 is mounted between the rear panel 5 of the container 1 and the wall behind it.

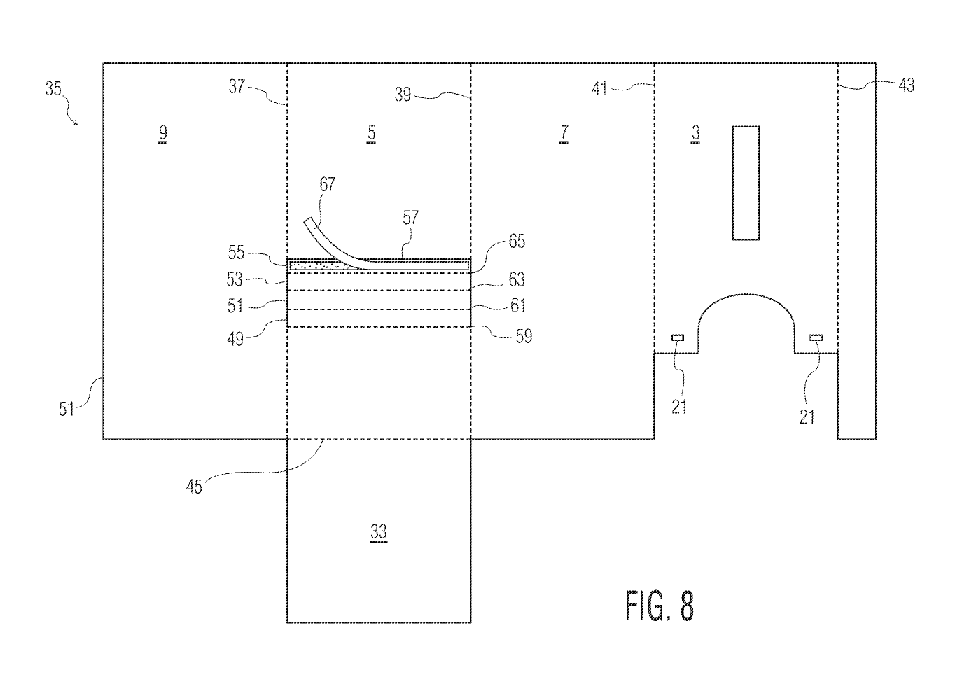

Referring now to FIG. 8 therein shown a sheet 35 of corrugated cardboard or like semi-rigid stock from which the container 1 can be assembled. The sheet 35 has a top edge and a bottom edge and is scored to form parallel fold lines 37, 39, 41, 43 extending from the top edge to the bottom edge. Fold line 37 is between right side panel 9 and rear panel 5. Fold line 39 is between left side panel 7 and rear panel 5. Fold line 41 is between left side panel 7 and front panel 3. A fold line 45 transverse to the lines 37, 39, 41, 43 separates the bottom panel 33 from the rear panel 5. It is not necessary that the optional bottom panel 33 be attached to the rear panel 5, and it may be similarly connected to either of the side panels 5, 7 and 9. Also, the order of the panels on the sheet 35 can be changed by rotating them in either direction. For example, the front panel 3 can be between fold lines 37 and 39 in which case the right side panel 9 would be between fold lines 39 and 41.

The container 1 is assembled by folding the bottom panel 33 along score line 45 rearwardly and upwardly until it is horizontal. The right side panel 9 is folded rearwardly along score line 37 until it is in a plane perpendicular to the plane of rear panel 5.

The rear panel 5 is folded along score line 39 until it is in a plane perpendicular to the plane of the left side panel 7. At this time right side panel 9 is parallel to left side panel 7. Front panel 3 is folded along score line 41 until it is perpendicular to sides panels 7 and 9 and parallel to rear panel 5. The exposed vertical edge 51 of the right side panel 9 is abutted against the inside surface of front panel 3 just inside the score line 43.

A fastener panel 47 is then folded back along the score line 43 until its inside surface engages the outside surface of the right side panel 9. Fastener panel 47 should always be at the one end of the sheet 35 so that it may be folded over and affixed to an adjacent panel.

The inside surface of the fastener panel 47 preferably has an adhesive coating which can be moistened to adhere it to the right side panel 9. More conveniently, the adhesive may be a pressure sensitive adhesive which employs a peel-off strip that can be removed to expose the tacky surface of the adhesive for joining the fastener panel 47 to the right side panel 9.

As can be seen in FIG. 4, the horizontal rear support 27 is provided by cutting and inwardly folding upon itself a portion of the rear panel 5 of the container 1. Referring to FIGS. 4 and 8, a hollow rectangular parallelepiped having a square cross section is formed by punching out a flap scored for forming fold lines between horizontal folds 49, 51, 53 and 55. To enable this there is a cut through the sheet 35 along line 57 and along the score lines 37 and 39 extending from cut line 57 to score line 59 which is immediately below fold 49. In addition to score line 59, score lines 61, 63 and 65 are formed below and parallel to cut line 39.

The flap is folded about score line 59 so that the fold 49 is in a horizontal plane with its uppermost surface atop the rear support 27 upon which a box 13 will rest. The flap is further folded along score line 61 so that fold 51 is in a plane parallel to the rear panel 5 of the container 1. The flap is further folded along score line 63 for placing fold 53 at the bottom of the rear support 27 and in a plane parallel to the floor 33 of the container 1. Finally, the flap is folded along score line 65 to enable fold 55 to be rotated upwardly into a plane parallel to the rear panel 5 of the container 1.

Preferably the fold 55 is slightly narrower than the folds 49, 51, and 53 which are of equal height, for enabling the uppermost edge of the fold 55 to engage the underside of the fold 49 while maintaining a square disposition for the rear support 27.

Fold 55 may be coated with an adhesive and covered with a peel away strip 67 which can be removed once the folds are completed to enable the fold 55 to be urged against the inside surface of the panel 5 for adhering fold 55 to the panel 5 so that the rear support 27 does not unravel. This provides a strong and stable horizontal platform upon which the rear of the lowermost box 13a can rest during normal storage and along which it can be slid as it is pushed rearwardly prior to removable from the stack.

The brackets 25 may be right angle brackets made from any rigid material including metal or plastic. For maximum strength, the brackets 25 can be inserted through horizontal slots 21 scored into the front panel 3 of the container 1.

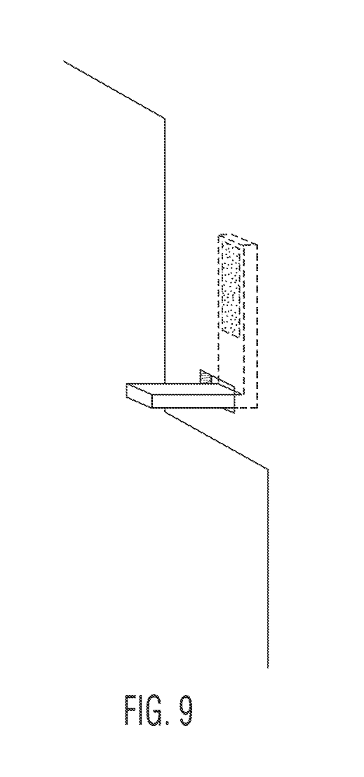

Referring additionally to FIG. 9, the inside surfaces of the vertical arms of the angle brackets 25 facing the outer surface of the front panel 3 can be coated with a pressure-sensitive adhesive covered by a peel away strip and pressed against, and thereby affixed to, the front panel 3. The horizontal arm of each angle bracket 25 rests on, and is supported by, the exposed inside edge of its respective slot 21 for stability and strength.

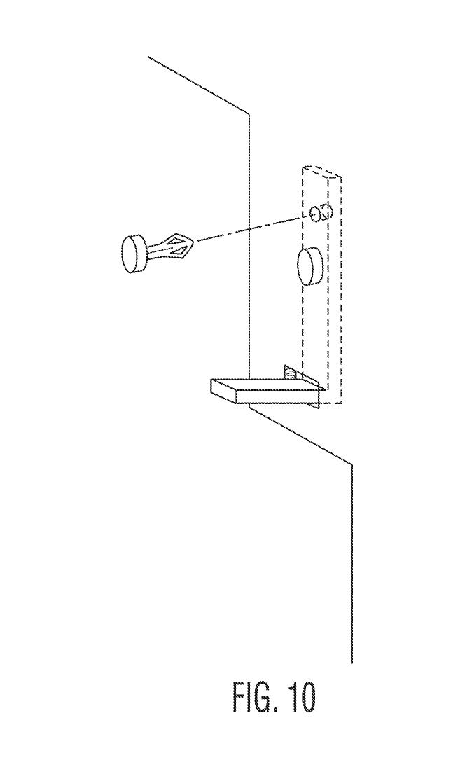

Alternatively, as shown in FIG. 10, the vertical arm of the bracket 25 can be apertured for receiving an expandable push pin fastener that can be inserted through the front panel 3 and the vertical arm from either side. Other types of conventional fasteners may employed as will be known to those skilled in the art. It is important that the portion of the fastener that extends into the interior of the container 1 not penetrate deeply enough to interfere with the downward movement of the stack of pizza boxes as each lowermost box 13a is withdrawn.

In instances where an adhesive used to affix the brackets forming the supports 25, and the panel on which the brackets are mounted are strong enough to withstand shearing forces on the inside surfaces of the container 1 due to the weight of the stacked boxes 13, the rear surfaces of the vertical arms of the brackets 25 can be adhered to the inside surface of the front panel 3 of the container 1 without forming, or inserting the brackets through, slots in the front panel 3 of the container 1. Here too a peel off strip can be used to expose an adhesive on the rear of the brackets' vertical arms which can then be pressed against the inside facing surface of the front panel 3.

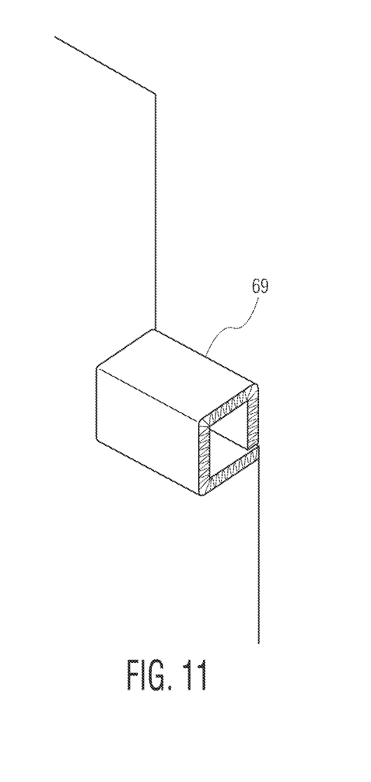

Referring now to FIG. 11 it can be seen that the vertical brackets 25 may be replaced with folded over flaps 69 scored into and punched from the front panel 3 at appropriate heights so that the top surface of each front support 69 is level with the rear support 27. Each front support 69 can be formed in a manner similar to that in which the rear support 27 is formed. That is, scored into the front panel at each side of the opening 19 can be a vertical flap having four sections, the lowermost three sections being of equal height and the uppermost one being slightly shorter so that when folded the vertical flap will form an open rectangular parallelepiped 69 as shown in FIG. 11 with the face of the front support 69 adjacent to the inside surface of the front panel 3 adhered to it with an adhesive.

Just as the angle brackets in the front of the container 1 can be replaced with an integral folded flap to form front supports, so too can the rear support 27 heretofore described as being formed from an integral flap 5 in the rear panel 5 of the container 1, be replaced with a plastic or metal bracket having a flat horizontal surface. The rear support 27 can have an L shaped cross section and be inserted through an elongated horizontal slot in rear panel 5 of the container 1 with its vertical member fastened to the outside of rear panel 5 by an adhesive or one or more mechanical fasteners. Alternatively, the vertical member of the L-shaped bracket can be fastened to the inside of rear panel 5 by an adhesive or one or more mechanical fasteners.

It is to be noted that the front supports 25 can be affixed not only to the front panel of the container 1 but also to the inside surfaces of the side panels 7, 9 of the container 1 at positions adjacent to the front panel 3.

It is desirable that the inner dimensions of the container 1, that is the length and width, be only slightly larger than the length and width of the pizza boxes to be stored in and dispensed from the container 1. In order to prevent jamming of the pizza boxes within the container 1, it is preferable to have each of the length and width of the inside of the container 1 exceed the outside length and width of the pizza boxes by ⅛ to one ¼ inch. The sum of the distances by which the front supports 25, on the one hand, and the rear support 27, on the other hand, extend toward one another should be greater than the distance by which the depth of the inside of the container 1 exceeds the depth D of the pizza boxes 13.

For a pizza box having a width W a depth D and a height H, the interior width of the container 1 is preferably in the range of W+⅛ inch to W+¼ inch. In the preferred embodiment of the invention, the preferred depth of the horizontal platforms of the front and rear supports are preferably each between ½ inch and 1 inch.

It is to be appreciated that the foregoing is a description of a preferred embodiment of the invention to which alterations and modifications may be made without departing from the spirit and scope of the invention. For example, in lieu of the elongated rear support 27 disposed beneath the rear opening 19, one or more supports similar to the front supports 25 can be provided on rear panel 5 of container 1, or on side panels 7, 9 near rear panel 5. As in the case of rear support 27, the rear supports should have horizontal supporting surfaces coplanar with the horizontal supporting surfaces of the front supports 25.

Moreover, although the invention has been described in the context of a container formed from corrugated board for low cost, light weight, ease of assembly and portability, the dispenser of the invention can be fabricated from rigid materials such as plastic, wood, or metal.

1. A container accordingly to claim 21 further
at least one rear support mounted on an inside surface of said container proximate said rear panel and distal from said front panel, and having an upward facing surface in said plane,
a rear opening intersected by said plane in said rear panel and having a width greater than W,
whereby the lowermost box of a stack of boxes within said container can be supported on said front support and said rear support with its bottom outer surface in said plane and dispensed from said container by pushing said lowermost box rearwardly partially through said rear opening and off of said front support, then lowering the front of said box below said front support thereby tilting said lowermost box away from the box in said stack immediately above said lowermost box, and then removing said lowermost box from said stack by pulling said lowermost box forward through said lower opening.

2. A container according to claim 1 wherein said rear opening has a height extending above said plane by a distance greater than H and less than 2H.

3. A container according to claim 1 wherein said one front support is a left front support mounted between said left side panel and said upper opening, and further comprising a right front support mounted on an inside surface of said container proximate said front panel between said right side panel and said upper opening, distal from said rear panel, and having an upward facing surface in said plane

4. A container according to claim 1 wherein said one rear support is mounted on said rear panel beneath said rear opening.

5. A container according to claim 1 wherein said one rear support is comprises a folded flap cut from said rear panel.

6. A container according to claim 3 wherein at least one of said left front support and said right front support comprises a folded flap cut from one of said front panel, said left side panel and said right side panel.

7. A container according to claim 3 wherein at least one of said left front support and said right front support comprises an angle bracket mounted on one of one of said front panel, said left side panel and said right side panel.

8. A container according to claim 1 wherein said front panel has a vertical slot with a length greater than H through which a plurality of boxes can be seen when stacked in said container.

9. A container according to claim 8 wherein said upper opening forms an arch in said front panel beneath said slot.

10. A sheet of semi-rigid material from which a container in accordance with claim 1 can be assembled, said sheet having three parallel fold lines each of which extends from a top edge of said sheet to a bottom edge of said sheet thereby defining said front panel, said right side panel, said rear panel and said left side panel,
said bottom edge along said right side panel being collinear with said bottom edge along said left side panel, front panel having an edge bordering said upper opening and offset from said bottom edge along said right side panel and said left side panel,
whereby said container can be assembled by folding said sheet along said three parallel fold lines for forming said hollow parallelepiped.

11. A sheet according to claim 10 wherein said rear panel has an opening corresponding to said rear opening.

12. A sheet according to claim 10 wherein said rear panel is scored for enabling an area of said rear panel to be punched out for forming said rear opening.

13. A sheet according to claim 10 wherein said rear panel is scored along three sides of a rectangle for enabling an area of said rear panel circumscribed by said rectangle to be punched out to form a flap hinged along a fourth side of said rectangle.

14. A sheet according to claim 13 wherein said rear panel has a plurality of parallel horizontal fold lines about which said flap can be folded for forming said rear support.

15. A sheet according to claim 14 further comprising an adhesive coating along a fold between two adjacent ones of said parallel horizontal fold lines for affixing said fold to said an area of said rear panel.

16. A sheet according to claim 10 further comprising a fifth panel laterally adjacent to and separated by a fourth score line from one of said right side panel, said rear panel, said left side panel and said front panel, and having a free edge extending between said top edge of said sheet and said bottom edge of said sheet, said fifth panel and one of said right side panel, said rear panel 6, said left side panel and said front panel most distal therefrom having cooperating means for fastening said fifth panel to said most distal panel when said sheet is folded about said fourth score line for maintaining said container as a parallelepiped.

17. A method of making the container of claim 1 from a sheet of semi-rigid material, comprising
scoring three parallel fold lines into said sheet, each fold line extending from a top edge of said sheet to a bottom edge of said sheet thereby defining said front panel, said right side panel, said rear panel and said left side panel,
making said bottom edge along said right side panel collinear with said bottom edge along said left side panel,
forming in said front panel an edge bordering said upper opening and offset from said bottom edge along said right side panel and said left side panel, and
folding said sheet along said three parallel fold lines for forming a hollow parallelepiped.

18. A method according to claim 17 further comprising
scoring an area of a said rear panel along three sides of a rectangle,
punching out said area of said rear panel circumscribed by said rectangle to form a rectangular opening and a flap hinged along a fourth side of said rectangle adjacent said opening.

19. A method according to claim 18 further comprising
scoring a plurality of parallel horizontal fold lines into said flap,
and folding said flap along said fold lines for forming said rear support.

20. (canceled)

21. A container for facilitating removal of the lowermost box from a stack of boxes, each of said boxes having a width W, a depth D and a height H, comprising,
a container having the general form of a hollow parallelepiped with a front panel, a rear panel, a left side panel and a right side panel,
said front panel having proximate a bottom end of said container a lower opening with a width greater than W and a height greater than H and an upper opening distal from said bottom end of said container and contiguous with said lower opening and having a width less than W,
at least one front support mounted on an inside surface of said container proximate said front panel and distal from said rear panel, and having an upward facing surface in a plane transverse to said front panel and intersecting said upper opening,
whereby the lowermost box of a stack of boxes within said container supported on said front support can be dispensed from said container by pushing said lowermost box rearwardly and off of said front support, lowering the front of said box below said front support thereby tilting said lowermost box away from the box in said stack immediately above said lowermost box, and then removing said lowermost box from said stack by pulling said lowermost box forward through said lower opening.
